(19) United States
(12) Patent Application Publication
(10) Pub. No.: US 2026/0132285 A1
(43) Pub. Date: May 14, 2026

(54) BINDER INCLUDING COPOLYMER COMPOSITION, ANODE FOR SECONDARY BATTERY INCLUDING SAME BINDER, AND SECONDARY BATTERY INCLUDING SAME ANODE

(71) Applicant: HANSOL CHEMICAL CO., LTD, Seoul (KR)

(72) Inventors: So-Hyun PARK, Jeollabuk-do (KR); Ji-Hye PARK, Jeollabuk-do (KR); Hyeon-Ji GWON, Jeollabuk-do (KR); Chan-Su PARK, Jeollabuk-do (KR); Gyun-Tae KIM, Jeollabuk-do (KR); Min-Ki CHO, Jeollabuk-do (KR); Chang-Beom KIM, Jeollabuk-do (KR); Se-Man KWON, Jeollabuk-do (KR)

(21) Appl. No.: 19/119,572

(22) PCT Filed: Oct. 13, 2023
(86) PCT No.: PCT/KR2023/015824

§ 371 Date: Apr. 9, 2025

(30) Foreign Application Priority Data
Oct. 14, 2022 (KR) 10-2022-0132245

(51) Int. Cl. C08L 33/10; C08L 29/04; H01M 4/02; H01M 4/62

(52) U.S. Cl. CPC C08L 33/10; C08L 29/04; H01M 4/622; C08L 2203/20; H01M 2004/027

(57) ABSTRACT

The present invention relates to a copolymer composition comprising a first copolymer including a monomer unit of vinyl alcohol and a monomer unit of vinyl amine, a second copolymer including a monomer unit of vinyl alcohol and a monomer unit of acrylate, and a crosslinking agent, and to an anode slurry, an anode, and a secondary battery, each comprising the copolymer composition.

### CROSS-REFERENCE TO RELATED APPLICATIONS

This application is a National Stage of International patent application PCT/KR2023/015824, filed on Oct. 13, 2023, which claims priority to foreign Korean patent application No. KR 10-2022-0132245, filed on Oct. 14, 2022, the disclosures of which are incorporated by reference in their entireties.

### TECHNICAL FIELD

The present disclosure relates to a copolymer composition usable as a binder, and a slurry, an electrode, and a secondary battery, each including the copolymer composition.

### BACKGROUND ART

With high energy density, lithium secondary batteries are being used extensively in electrical, electronic, telecommunication, and computer fields. In addition, application fields of lithium secondary batteries are being expanded to high-capacity secondary batteries for hybrid vehicles, electric vehicles, and the like, in addition to small lithium secondary batteries for portable electronic devices.

As such application fields expand, lithium secondary batteries are required to have longer life characteristics, as well as higher capacity. One example of methods for making the capacity of a lithium secondary battery higher may involve using a silicon atom-containing active material in an anode.

The application of silicon atom-containing active materials, which involves intercalation and deintercalation of a higher amount of lithium than existing carbon-based active materials, may lead to the expectation of improved battery capacity. However, in the case of such silicon-containing active materials, the intercalation and deintercalation of lithium involve considerable volume changes. For this reason, anode active material layers expand and contract significantly during charge and discharge.

As a result, there have been the following problems: deterioration in conductivity between anode active materials, blockage of a conductive path between anode active materials and a current collector, and degradation of secondary battery cycling performance.

However, various existing binders that have been developed (such as polyacrylic acid (PAA), PAA/carboxymethyl cellulose (CMC), Na-PAA, crosslinked PAA, alginate, and polyvinyl alcohol (PVA)) lack adhesive strength or lack durability due to extremely brittle electrodes, and the current situation is that solving the volume expansion problem, described above, is deemed highly unlikely.

In the meantime, research has been recently conducted on suppressing the expansion of silicon-containing active materials using partially crosslinked binders. However, suppressing the expansion of such active materials is still insufficient, resulting in the following problems: electrode delamination occurs due to continuous destruction and reformation of solid electrolyte interphase (SEI) layers, and battery performance is degraded due to lithium-ion consumption.

Therefore, a binder enabling the capacity retention rate of secondary batteries to be obtainable by addressing these problems is required.

### DOCUMENT OF RELATED ART

### Patent Document

(Patent Document 1) Korean Patent Application Publication No. 10-2016-0024921

### DISCLOSURE

### Technical Problem

Accordingly, the present disclosure aims to provide a copolymer composition capable of preparing a slurry composition having excellent binding strength and ability to suppress electrode expansion.

Furthermore, the present disclosure aims to provide an electrode (especially an anode) having excellent performance, the electrode to which the above slurry composition is applied, and a secondary battery including the electrode and having an excellent capacity retention rate per cycle.

However, the problems to be solved by the present application are not limited to the aforementioned description, and other problems not mentioned can be clearly understood by those skilled in the art from the following description.

### Technical Solution

In one aspect of the present application, a copolymer composition including: a first copolymer including vinyl alcohol monomer unit and a vinyl amine-based monomer unit;
a second copolymer including a vinyl alcohol monomer unit and an acrylic acid salt-based monomer unit; and
a crosslinking agent
is provided.

In another aspect of the present application, an anode slurry including: the copolymer composition; and
an anode active material
is provided.

In a further aspect of the present application, an anode including: a current collector; and
an anode active material layer including the copolymer composition, the anode active material layer formed on the current collector,
is provided.

In yet another aspect of the present application,
a secondary battery including the anode
is provided.

### Advantageous Effects

A copolymer composition of the present disclosure can be used in an anode slurry, thus increasing the binding strength to an anode current collector, and can suppress anode expansion, thus improving the capacity retention rate of a secondary battery per cycle.

### DESCRIPTION OF DRAWINGS

FIG. 1 illustrates crosslinking mechanisms of a copolymer composition of the present application in which glutaraldehyde is used as a crosslinking agent.

### BEST MODE

Hereinafter, the action and effect of the present disclosure will be described in more detail through specific embodiments of the present disclosure. However, these embodiments are provided only for illustrative purposes of the present disclosure, and the scope of the present disclosure is not limited thereby.

Before discussing the details, it should be noted that all terms or words used herein and those used in the appended claims are not construed as being limited to general and dictionary meanings but will be interpreted based on the meanings and concepts corresponding to the technical ideas of the present disclosure, following the principle that any inventor is allowed to define the concepts of terms as appropriate to describe the disclosure thereof in the best mode.

Therefore, the embodiments described herein are configured merely as one of the most preferable examples of the present disclosure and do not exhaustively represent the technical idea of the present disclosure. Accordingly, it should be appreciated that there may be various equivalents and modifications that can replace these embodiments as of the filing date of the present application.

As used herein, the singular forms are intended to include the plural forms, unless the context clearly indicates otherwise. It will be further understood that the terms “comprise,” “include,” “have,” and the like when used herein, are intended to specify the presence of stated features, integers, steps, constituent elements, or combinations thereof but do not preclude the possibility of the presence or addition of one or more other features, integers, steps, constituent elements, or combinations thereof.

As used herein, the expression “a to b” to represent a numerical range is defined as ≥a and ≤b.

A copolymer composition, according to one aspect of the present application, may include a first copolymer including a vinyl alcohol monomer unit and a vinyl amine-based monomer unit, a second copolymer including a vinyl alcohol monomer unit and an acrylic acid salt-based monomer unit, and a crosslinking agent.

The crosslinking agent may allow for crosslinking of the first copolymer and the second copolymer having polar functional groups to increase the adhesive strength between active materials and a current collector and minimize structural changes and damage to an electrode resulting from volume changes in active materials.

In one embodiment, the first copolymer may further include one or more selected from a vinyl acetate monomer unit and an N-vinylformamide-based monomer unit, and the second copolymer may further include one or more selected from an acrylate-based monomer unit and a vinyl acetate monomer unit.

The first copolymer includes a hydroxyl group and an amine group. Thus, when used as a binder of an anode slurry, the first copolymer may form a strong hydrogen bond with silicon, serving as an anode active material, and form a coordinate bond with an anode current collector, thus increasing the binding strength between the current collector and silicon.

In the meantime, the second copolymer may enable the binder of the anode slurry to become flexible based on the ethylene skeletal structure and suppress a volume change in silicon, the anode active material. In addition, an alkali metal ion substituted at a terminal of the acrylic acid salt-based monomer unit may help improve ionic conductivity. Furthermore, the stretched chains may interact with the anode active material to form a porous electrode having a densely packed structure and enable the formation of a stable SEI layer.

The hydroxyl group of the first copolymer and the carboxyl group of the second copolymer are chemically and/or physically crosslinkable. Through this, the volume change in silicon, the anode active material, may be suppressed.

In one embodiment, the vinyl amine-based monomer unit of the first copolymer may be one or more selected from the group consisting of vinyl amine and 1-methyl vinyl amine, but is not limited thereto.

In addition, the acrylic acid salt-based monomer unit of the second copolymer may be one or more selected from the group consisting of acrylic acid and methacrylic acid, but is not limited thereto.

In one embodiment, the N-vinylformamide-based monomer unit of the first copolymer may be one or more selected from the group consisting of N-vinylformamide and N-isopropenylformamide, but is not limited thereto.

In addition, the acrylate-based monomer unit of the second copolymer may be one or more selected from the group consisting of methyl acrylate, methyl methacrylate, ethyl acrylate, ethyl methacrylate, propyl acrylate, propyl methacrylate, isopropyl acrylate, isopropyl methacrylate, butyl acrylate, butyl methacrylate, sec-butyl acrylate, sec-butyl methacrylate, tert-butyl acrylate, tert-butyl methacrylate, and ethyl hexyl methacrylate, but is not limited thereto.

In one embodiment, the first copolymer, based on 100 mol % of the total content thereof, may include 50 mol % or more and 90 mol % or less of the vinyl alcohol monomer unit and 1 mol % or more and 50 mol % or less of the vinylformamide (N-vinylformamide)-based monomer unit.

In one embodiment, the second copolymer, based on 100 mol % of the total content thereof, may include 1 mol % or more and 30 mol % or less of the vinyl alcohol monomer unit and 50 mol % or more and 90 mol % or less of the acrylic acid salt-based monomer unit.

The contents of the first copolymer and the second copolymer may be adjusted by changing the degree of hydrolysis in the processes of preparing the first copolymer and the second copolymer.

In one embodiment, the first copolymer may include a monomer repeating unit represented by Formula 1 below, and the second copolymer may include a monomer repeating unit represented by Formula 2 below.

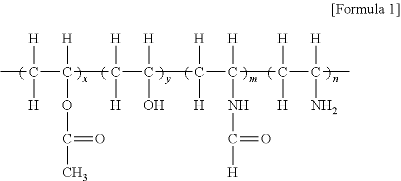

In Formula 1,
0≤x≤15 mol %, 50≤y≤90 mol %, 0≤m≤30 mol %, and 1≤n≤50 mol %.

In Formula 1, x, y, m, and n represent the mol % of each monomer unit.

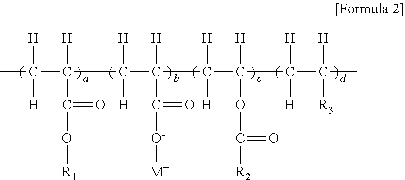

In Formula 2,
R₁ and R₂ are the same or different from each other and are each independently hydrogen or a straight-chain or branched-chain hydrocarbon having 1 to 5 carbon atoms,
R₃ is a hydroxyl (—OH) group,
M is an alkali metal,
0≤a≤5 mol %, 50≤b≤90 mol %, 0≤c≤5 mol %, and 1≤d≤30 mol %.

In Formula 2, a, b, c, and d represent the mol % of each monomer unit.

In addition, M in Formula 2 may be any one selected from the group consisting of lithium (Li), potassium (K), and sodium (Na), but is not limited thereto.

In the meantime, R₁ and R₂ in Formula 2 may be each independently any one selected from the group consisting of hydrogen, methyl, ethyl, n-propyl, isopropyl, n-butyl, isobutyl, sec-butyl, tert-butyl and n-pentyl, but is not limited thereto.

In one embodiment, the copolymer composition, based on 100 wt % of the total weight thereof, may include 10 wt % or more and 90 wt % or less of the first copolymer and 10 wt % or more and 90 wt % or less of the second copolymer.

The higher the proportion of the first copolymer content within the content ranges of the first copolymer and the second copolymer of the copolymer composition, the more improved the binding strength of an anode when the copolymer composition is used as an anode binder.

In addition, the higher the proportion of the second copolymer content within the content ranges of the first copolymer and the second copolymer of the copolymer composition, the more improved the stability and dispersibility of an anode slurry when the copolymer composition is used as an anode binder.

The greater the extent to which the contents of the first copolymer and the second copolymer in the copolymer composition do not fall within the scope of the present application, the more likely one or more of the dispersion stability of an anode slurry composition, the binding strength of an anode, and characteristics of a secondary battery may deteriorate when the copolymer composition is used as an anode binder.

In particular, delamination of an electrode having low binding strength to a current collector may occur during the drying and rolling processes, and when increasing the rolling density of an electrode, separation of the electrode from a slurry applied thereon may occur. In addition, during battery operation, low binding strength to an electrode plate may cause delamination of an electrode that is wet and swollen in an electrolyte, resulting in reduced operational stability of the battery.

In one embodiment, the first copolymer may be a random or block copolymer, and the second copolymer may be a random or block copolymer.

In one embodiment, the first copolymer may have a number average molecular weight of 10,000 or greater and 1,000,000 or smaller, and the second copolymer may have a number average molecular weight of 10,000 or greater and 1,000,000 or smaller.

In the meantime, the first copolymer may be prepared by hydrolysis of a copolymer including the vinyl acetate monomer unit and the N-vinylformamide-based monomer unit.

In other words, the vinyl acetate monomer unit and the N-vinylformamide-based monomer unit of the first copolymer may be hydrolyzed to the vinyl alcohol monomer unit and the vinyl amine-based monomer unit, respectively.

In addition, the second copolymer may be prepared by hydrolysis of a copolymer including the acrylate-based monomer unit and the vinyl acetate monomer unit.

In other words, the acrylate-based monomer unit and the vinyl acetate monomer unit of the second copolymer may be hydrolyzed to the acrylic acid salt-based monomer unit and the vinyl alcohol monomer unit, respectively.

An alkali metal hydroxide may be used in the hydrolysis for preparing the first copolymer and the second copolymer, but there are no limitations.

In one embodiment, the crosslinking agent may include 2 or more aldehyde groups.

For example, the crosslinking agent may be glutaraldehyde, succinaldehyde, glyoxal aldehyde, adipic dialdehyde, or a combination thereof.

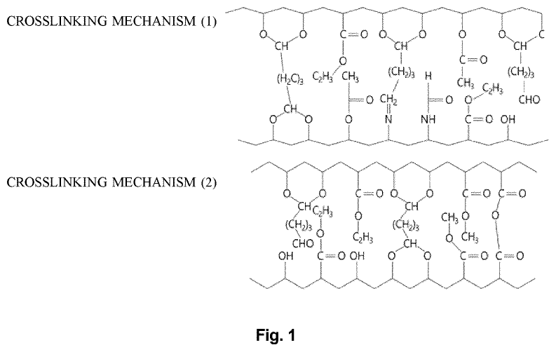

FIG. 1 illustrates presumed crosslinking mechanisms of the copolymer composition of the present application in which glutaraldehyde is used as the crosslinking agent.

In one embodiment, the copolymer composition, based on 100 wt % of the total weight thereof, may include 0.7 wt % or more and 2.8 wt % or less of the crosslinking agent.

For example, the copolymer composition, based on 100 wt % of the total weight thereof, may include 1 wt %, 1.5 wt %, 2 wt %, or 2.5 wt % of the crosslinking agent.

The higher the content of the crosslinking agent, the higher the crosslinking rate when the copolymer composition is crosslinked under the same pH.

In the meantime, when the content of the crosslinking agent exceeds the content range of the present application, the binding strength of the copolymer composition may be significantly reduced when the copolymer composition is crosslinked under the same pH.

In addition, when the content of the crosslinking agent falls below the content range of the present application, the electrode expansion rate significantly increases when the copolymer composition is crosslinked under the same pH, so the life of a lithium secondary battery to which the copolymers are applied may be degraded.

In one embodiment, the copolymer composition may have a pH of 6 or higher and 12 or lower.

The crosslinking rate may decrease with the increasing pH of the copolymer composition. In addition, the binding rate of a slurry composition using the copolymer composition may increase with the increasing pH of the copolymer composition.

In the meantime, when the pH of the copolymer composition is lower than 6, the stability of a slurry including the copolymer composition may be significantly reduced, making the use thereof in product production unsuitable.

In addition, when the pH of the copolymer composition exceeds 12, the electrode expansion rate of an electrode using the copolymer composition may significantly increase, leading to deterioration in battery performance and degradation of battery life.

The pH of the copolymer composition may be adjusted by adding a pH regulator to the copolymer composition.

As the pH regulator, any pH regulator (especially an acidic substance) capable of adjusting the pH of the copolymer composition to 6 or higher and 12 or lower may be used.

For example, monomers such as maleic acid and acrylic acid or a combination thereof may be used, and polymers such as PAA may be used.

In addition, the first copolymer and the second copolymer of the copolymer composition may have a crosslinking rate of 45% or higher and 80% or lower.

For example, the crosslinking rate may be 50% or higher and 80% or lower.

An anode slurry, according to another aspect of the present application, may include the above copolymer composition and an anode active material.

In other words, the copolymer composition may be used as an anode binder.

The peel strength between a copper current collector and an anode active material layer formed using the anode slurry may be 10 dyne/cm² or more and 15 dyne/cm² or less.

The anode active material may be a compound including one or more selected from the group consisting of carbon-based materials, silicon, alkali metals, alkaline earth metals, elements of group 13, elements of group 14, transition metals, and rare-earth elements. Preferably, the anode active material is silicon or a silicon-containing compound.

Examples of the carbon-based materials may include synthetic graphite, natural graphite, hard carbon, soft carbon, and the like, but are not limited thereto. The silicon-containing anode active material is not particularly limited in type as long as it is silicon or a silicon-containing compound. However, the silicon-containing anode active material is preferably one or more selected from the group consisting of Si, SiOₓ (where 0<x<2), Si—Y alloys (where Y is an alkali metal, an alkaline earth metal, an element of group 13, an element of group 14, a transition metal, a rare-earth metal, or a combination thereof, but not Si), and Si—C composites.

Additionally, when mixed with other anode active materials, which differ from the silicon-containing anode active material, for use as the anode active material, the silicon-containing anode active material may be included in an amount of 8 wt % or more of the total weight of the anode active material.

The anode active material layer, with respect to the total weight thereof, may include 50 to 90 wt %, preferably 60 to 80 wt %, of the anode active material.

When less than 50 wt % of the anode active material is included, the energy density may decrease, making it impossible to manufacture a battery with high energy density. When more than 90 wt % of the anode active material is included, the contents of a conductive additive and the binder decrease, so the electrical conductivity may decrease, and the adhesive strength between the electrode active material layer and the current collector may decrease.

In the meantime, the anode slurry, with respect to the total weight thereof, may include 1 to 35 wt % of the copolymer composition binder of the present application. With less than 1 wt % of the copolymers, the physical properties of the anode deteriorate, so the anode active material and the conductive additive may be delaminated. With more than 35 wt % of the copolymers, the proportions of the anode active material and the conductive additive may relatively decrease, resulting in reduced battery capacity and reduced electrical conductivity of the anode.

In addition, the anode slurry may further include a polymer in addition to the copolymer composition of the present application. Specific examples of the polymer may include polyvinylidene fluoride (PVDF), PVA, PAA, PAA metal salts (Metal-PAA), polymethacrylic acid (PMA), polymethyl methacrylate (PMMA), polyacrylamide (PAM), polymethacrylamide, polyacrylonitrile (PAN), polymethacrylonitrile, polyimide (PI), chitosan, starch, polyvinylpyrrolidone, tetrafluoroethylene, polyethylene, polypropylene, ethylene-propylene-diene polymers (EPDMs), sulfonated-EPDMs, styrene-butadiene rubber (SBR), fluoroelastomers, hydroxypropyl cellulose, regenerated cellulose, various copolymers thereof, and the like, but are not limited thereto.

An anode, according to a further aspect of the present application, may include a current collector and an anode active material layer including the above copolymer composition of the present application, the anode active material layer formed on the current collector.

The anode active material layer may further include a conductive additive. The conductive additive is used to further improve the conductivity of the anode active material. Such a conductive additive is not particularly limited as long as it is conductive and does not cause chemical changes in batteries in the art to which the present disclosure pertains. Examples of the conductive additive used may include: graphite, such as natural graphite and synthetic graphite; carbon black, such as carbon black, acetylene black, Ketjen black, channel black, furnace black, lamp black, and thermal black; conductive fibers, such as carbon fibers and metal fibers; metal powders, such as carbon fluoride, aluminum, and nickel powder; conductive whiskers, such as zinc oxide and potassium titanate; conductive metal oxides, such as titanium oxide; polyphenylene derivatives; and the like.

The anode active material layer, with respect to the total weight thereof, may include 5 to 30 wt %, preferably 15 to 25 wt %, of the conductive additive. When less than 5 wt % of the conductive additive is included, the electrical conductivity of the anode is reduced. When more than 30 wt % of the conductive additive is included, the proportions of the silicon-based anode active material and the binder may relatively decrease, resulting in reduced battery capacity. In addition, the content of the anode active material decreases because the binder content needs to increase to keep the anode active material layer, making it impossible to manufacture a battery with high energy density.

Because the anode active material layer includes the copolymer composition of the present application, the anode of the present application may suppress the volume expansion of the anode active material from occurring when a secondary battery is charged and discharged and improve the capacity retention rate per cycle.

The anode may be manufactured by the following steps: (a) preparing a composition for forming the anode active material layer, the composition including the anode active material and the copolymer composition of the present application, and (b) applying the composition for forming the anode active material layer on an anode current collector and then drying the resulting product.

The composition for forming the anode active material layer is prepared in an anode slurry form. A solvent used to prepare the slurry form should be easily dried. In addition, any of those capable of well-dissolving the copolymer composition binder of the present application but enabling the anode active material to remain dispersed without being dissolved is the most preferable.

As the solvent according to the present application, an organic solvent or water is usable. In addition, an organic solvent including one or more selected from the group consisting of methylpyrrolidone, dimethylformamide, isopropyl alcohol, acetonitrile, methanol, ethanol, and tetrahydrofuran is applicable as the organic solvent.

The composition for forming the anode active material layer may be mixed by common stirring methods using common mixers, for example, a latex mixer, a high-speed shear mixer, a homomixer, and the like.

Step (b) is to manufacture the anode for a lithium secondary battery by applying the composition for forming the anode active material layer, prepared in Step (a), on the anode current collector and then drying the resulting product.

Specifically, the anode current collector may be selected from the group consisting of copper, stainless steel, titanium, silver, palladium, nickel, alloys thereof, and combinations thereof. The surface of the stainless steel may be treated with carbon, nickel, titanium, or silver, and an aluminum-cadmium alloy may be used as the above alloy. In addition, calcined carbon, a non-conductive polymer the surface of which is treated with a conductive additive, a conductive polymer, or the like may be used.

The composition for forming the anode active material layer, prepared in Step (a), is applied onto the anode current collector, and the current collector may be coated to have a suitable thickness depending on the desired thickness to be formed, which is preferably selected appropriately within the range of 10 to 300 μm.

In this case, there are no limitations in methods of applying the slurry-form composition for forming the anode active material layer. For example, methods such as doctor blade coating, dip coating, gravure coating, slit die coating, spin coating, comma coating, bar coating, reverse roll coating, screen coating, and cap coating may be performed to manufacture the anode.

The resulting product obtained after the application is dried to finally manufacture the anode for a secondary battery (especially a lithium secondary battery) in which the anode active material layer is formed.

A battery, according to yet another aspect of the present application, may include an anode in which a current collector and the above anode active material layer on the current collector are formed.

The battery may be a secondary battery (especially a lithium secondary battery) including a cathode, the anode, a separator to be interposed between the cathode and the anode, and an electrolyte solution.

When repeatedly performing 500 cycles of charge and discharge, the secondary battery may have a capacity retention rate of 80% or higher.

For example, the capacity retention rate may be 83% or higher, 85% or higher, or 90% or higher.

In addition, when repeatedly performing 500 cycles of charge and discharge, the secondary battery may have an electrode expansion rate of 60% or lower.

For example, the electrode expansion rate may be 55% or lower, 50% or lower, 45% or lower, or 40% or lower.

The configurations of the cathode, the separator, and the electrolyte solution of the lithium secondary battery are not particularly limited in the present disclosure and follow what is known in the related art.

The cathode includes a cathode active material formed on a cathode current collector.

The cathode current collector is not particularly limited as long as it is highly conductive and does not cause chemical changes in batteries in the art to which the present disclosure pertains. Examples of the cathode current collector used may include stainless steel, aluminum, nickel, titanium, calcined carbon, or aluminum or stainless steel the surface of which is treated with carbon, nickel, titanium, silver, and the like. In this case, the cathode current collector used may have various forms, such as a sheet, a foil, a net, a porous body, a foam, a non-woven body, or a film with fine protrusions and depressions formed on the surface thereof so that the adhesive strength to the cathode active material is increased.

Any cathode active material available in the art to which the present disclosure pertains is usable as the cathode active material constituting a cathode active material layer. Specific examples of such a cathode active material may include: lithium metal; a lithium cobalt-based oxide, such as LiCoO₂; a lithium manganese-based oxide, such as Li₁₊ₓMn₂₋ₓO₄ (where x is in the range of 0 to 0.33), LiMnO₃, LiMn₂O₃, and LiMnO₂; a lithium copper oxide, such as Li₂CuO₂; a vanadium oxide, such as LiV₃O₈, LiFe₃O₄, V₂O₅, and Cu₂V₂O₇; a lithium nickel-based oxide represented by LiNi₁₋ₓMₓO₂ (where M is Co, Mn, Al, Cu, Fe, Mg, B, or Ga, and x is in the range of 0.01 to 0.3); a lithium manganese composite oxide represented by LiMn₂₋ₓMₓO₂ (where M is Co, Ni, Fe, Cr, Zn, or Ta, and x is in the range of 0.01 to 0.1) or Li₂Mn₃MO₈ (where M is Fe, Co, Ni, Cu, or Zn); a lithium-nickel-manganese-cobalt-based oxide represented by Li(NiₐCo_{b}Mn_{c})O2 (where 0<a<1, 0<b<1, 0<c<1, and a+b+c=1); sulfur or a disulfide compound; a phosphate, such as LiFePO₄, LiMnPO₄, LiCoPO₄, and LiNiPO₄; Fe₂(MoO₄)₃; and the like, but are not limited thereto.

In this case, the cathode active material layer may further include a binder, a conductive additive, a filler, other additives, and the like, in addition to the cathode active material, and the conductive additive is the same as that described above for the anode for a lithium secondary battery.

In addition, examples of the binder may include PVDF, PVA, PAA, PMA, PMMA, PAM, polymethacrylamide, PAN, polymethacrylonitrile, PI, chitosan, starch, hydroxy propyl cellulose, regenerated cellulose, polyvinylpyrrolidone, tetrafluoroethylene, polyethylene, polypropylene, EPDMs, sulfonated-EPDMs, SBR, fluoroelastomers, various copolymers thereof, and the like, but are not limited thereto.

While the separator may be made of a porous substrate, any porous substrate commonly used in electrochemical devices is usable as the porous substrate. For example, a polyolefin-based porous membrane or non-woven fabric may be used, but the separator is not particularly limited thereto.

The separator may be a porous substrate made of any one or a mixture of two or more selected from the group consisting of polyethylene, polypropylene, poly butylene, polypentene, polyethylene terephthalate, polybutylene terephthalate, polyester, polyacetal, polyamide, polycarbonate, PI, polyetheretherketone, polyethersulfone, polyphenylene oxide, polyphenylene sulfide, and polyethylene naphthalate.

The electrolyte solution of the lithium secondary battery, which is a lithium salt-containing non-aqueous electrolyte solution, is composed of a solvent and a lithium salt. As the solvent, a non-aqueous organic solvent, an organic solid electrolyte, an inorganic solid electrolyte, and the like are used.

Examples of the lithium salt, a material that is easily dissolved in the non-aqueous electrolyte solution, used may include LiCl, LiBr, LiI, LiClO₄, LiBF₄, LiB₁₀Cl₁₀, LiPF₆, LiAsF₆, LiSbF₆, LiAlCl₄, LiSCN, LiC₄BO₈, LiCF₃CO₂, LiCH₃SO₃, LiCF₃SO₃, LiN(SO₂CF₃)₂, LiN(SO₂F)₂, LiN(SO₂C₂F₅)₂, LiC₄F₉SO₃, LiC(CF₃SO₂)₃, (CF₃SO₂)·2NLi, lithium chloroborane, lithium lower aliphatic carboxylate, lithium 4-phenyl borate imide, and the like.

Examples of the non-aqueous organic solvent used may include aprotic organic solvents, such as N-methyl-2-pyrrolidone, propylene carbonate, ethylene carbonate, butylene carbonate, dimethyl carbonate, diethyl carbonate, ethyl methyl carbonate, gamma-butyrolactone, 1,2-dimethoxy ethane, 1,2-diethoxy ethane, tetrahydroxy franc, 2-methyl tetrahydrofuran, dimethyl sulfoxide, 1,3-dioxolane, 4-methyl-1,3-dioxene, diethyl ether, formamide, dimethylformamide, dioxolane, acetonitrile, nitromethane, methyl formate, methyl acetate, phosphoric acid triester, trimethoxy methane, dioxolane derivatives, sulfolane, methylsulfolane, 1,3-dimethyl-2-imidazolidinone, propylene carbonate derivatives, tetrahydrofuran derivatives, ether, methyl propionate, and ethyl propionate.

Examples of the organic solid electrolyte used may include polyethylene derivatives, polyethylene oxide derivatives, polypropylene oxide derivatives, phosphoric acid ester polymers, poly agitation lysine, polyester sulfide, PVA, PVDF, polymers including secondary dissociation groups, and the like.

Examples of the inorganic solid electrolyte used may include nitrides, halides, sulfates, and the like of Li, such as Li₃N, LiI, Li₅NI₂, Li₃N—LiI—LiOH, LiSiO₄, LiSiO₄—LiI—LiOH, Li₂SiS₃, Li₄SiO₄, Li₄SiO₄—LiI—LiOH, and Li₃PO₄—Li₂S—SiS₂.

In addition, the non-aqueous electrolyte solution may further include other additives for the purposes of improving the charge and discharge characteristics, flame retardancy, and the like. Examples of the additives may include pyridine, triethylphosphite, triethanolamine, cyclic ether, ethylene diamine, n-glyme, hexaphosphoric acid triamide, nitrobenzene derivatives, sulfur, quinone imine dyes, N-substituted oxazolidinone, N,N-substituted imidazolidine, ethylene glycol dialkyl ether, ammonium salts, pyrrole, 2-methoxyethanol, aluminum trichloride, fluoroethylene carbonate (FEC), propene sultone (PRS), vinylene carbonate (VC), and the like.

The lithium secondary battery, according to the present disclosure, may be subjected to folding and lamination stacking processes of the separator and the electrodes, in addition to a typical winding process. Additionally, a case of the battery may be cylindrical, prismatic, pouch-type, coin-type, or the like.

### MODE FOR INVENTION

Hereinafter, the present application will be described in more detail using the following examples. However, the present application is not limited thereto.

### [Preparation Example 1] Preparation of First Copolymer

Vinyl acetate and N-vinylformamide were continuously supplied to a reactor into which nitrogen was blown and then allowed to react at a temperature of 60° C., thereby synthesizing a copolymer of vinyl acetate and vinylformamide (PVAc-co-PVNF).

A mixture containing the synthesized PVAc-co-PVNF was recovered and introduced into methanol in which KOH was dissolved to hydrolyze the acetate functional group of PVAc-co-PVNF, thereby obtaining a copolymer of vinyl alcohol and N-vinylformamide (PVOH-co-PVNF) in a swollen gel form.

The obtained gel was crushed into fine particles, washed with methanol, introduced into methanol in which an alkaline catalyst was dissolved, further hydrolyzed, and washed to remove soluble salts and by-products, thereby obtaining a first copolymer of vinyl alcohol and vinyl amine (PVOH-co-PVAm).

### [Preparation Example 2] Preparation of Second Copolymer

To a reactor, 1,050 g of distilled water and 10 g of alkyldiphenyloxide disulfonate were added, followed by blowing nitrogen thereinto with stirring for 1 hour.

Then, 2.5 g of potassium persulfate was added, and the reactor was heated to a temperature of 60° C. Next, 110 g of vinyl acetate and 330 g of ethyl acrylate were added dropwise for 3 hours, and the same temperature was maintained for 2 hours while terminating the reaction, thereby obtaining a vinyl acetate-ethyl acrylate copolymer with 30 wt % of solid content.

To the reactor, 100 g of the vinyl acetate-ethyl acrylate copolymer with 30 wt % of solid content, 150 g of ethanol, a hydroxide, and an organic salt were added, followed by performing hydrolysis with stirring at a temperature of 60° C. for 4 hours.

After the completion of the hydrolysis, the precipitated hydrolysate was dissolved in distilled water, heated to a temperature of 80° C., stirred for 8 hours, and stripped, thereby preparing a second copolymer.

### [Preparation Example 3] Preparation of Copolymer Composition

The first copolymer and the second copolymer were mixed at a weight ratio of 70:30 (the weight of the first copolymer:the weight of the second copolymer), and a pH regulator (PAA) was added to achieve the desired pH. Then, 0.5 to 3 wt % of glutaraldehyde serving as a crosslinking agent, based on 100 wt % of the total copolymer composition weight, was introduced and stirred, thereby preparing the copolymer composition.

### [Preparation Example 4] Manufacture of Lithium Secondary Battery

An anode slurry was prepared by mixing 16 g of SiOx and 80 g of synthetic graphite, serving as electrode active materials, 1 g of carbon nanotubes, 3 g of a binder including the copolymer composition prepared according to Preparation Example 3, and distilled water.

Such a prepared anode slurry was evenly applied onto a copper current collector. The resulting compound, which was then dried at a temperature of 110° C., was rolled and thermally treated in a vacuum oven at a temperature of 110° C. for 4 hours or more, thereby preparing an anode.

Afterward, a lithium salt-containing non-aqueous electrolyte solution was used as an electrolyte, and a polyolefin separator was interposed between a cathode and the anode, followed by manufacturing a lithium secondary battery without distinguishing the form of the lithium secondary battery into a pouch or coin cell type.

As the non-aqueous electrolyte, a LiPF₆ electrolyte dissolved at a concentration of 1 M in a solvent in which ethylene carbonate, ethyl methyl carbonate, and diethyl carbonate were mixed at a volume ratio of 3:5:2 was used.

### Example 1

When preparing a copolymer composition, prepared according to Preparation Example 3, the pH was adjusted to 7, and 1.5 wt % of glutaraldehyde, serving as the crosslinking agent, was introduced based on 100 wt % of the total weight of the copolymer composition.

Using the prepared copolymer composition, a lithium secondary battery was manufactured according to Preparation Example 4.

### Example 2

A lithium secondary battery was manufactured in the same manner as in Example 1, except for adjusting the pH to 9 when preparing the copolymer composition, prepared according to Preparation Example 3.

### Example 3

A lithium secondary battery was manufactured in the same manner as in Example 1, except for adjusting the pH to 12 when preparing the copolymer composition, prepared according to Preparation Example 3.

### Comparative Example 1

A lithium secondary battery was manufactured in the same manner as in Example 1, except for introducing 3 wt % of glutaraldehyde, serving as the crosslinking agent, based on 100 wt % of the total weight of the copolymer composition when preparing the copolymer composition, prepared according to Preparation Example 3.

### Comparative Example 2

A lithium secondary battery was manufactured in the same manner as in Example 1, except for introducing 0.5 wt % of glutaraldehyde, serving as the crosslinking agent, based on 100 wt % of the total weight of the copolymer composition when preparing the copolymer composition, prepared according to Preparation Example 3.

### Comparative Example 3

A lithium secondary battery was manufactured in the same manner as in Example 1, except for adjusting the pH to 3 when preparing the copolymer composition, prepared according to Preparation Example 3.

### Comparative Example 4

A lithium secondary battery was manufactured in the same manner as in Example 1, except for adjusting the pH to 5 when preparing the copolymer composition, prepared according to Preparation Example 3.

### [Evaluation Example 1] Evaluation of Crosslinking Rate of Copolymer Composition

The crosslinking rates of the first copolymer and the second copolymer of the copolymer compositions used in Examples 1 to 3 and Comparative Examples 1 to 4 were measured/calculated through a gel content measurement method.

For the measurement of the crosslinking rate of the first copolymer and the second copolymer of the binder composition (copolymer composition), about 3 g of each copolymer composition of Examples 1 to 3 and Comparative Examples 1 to 4, prepared according to Preparation Example 3, was first applied onto a glass plate washed with MeOH and then coated using a glass rod.

Then, the copolymer composition was crosslinked by thermal treatment in vacuo at a temperature of 110° C. for 12 hours or more, thereby manufacturing a film.

After drying, 0.7 g of the film, which was torn off with a razor, was placed in a 250 ml Erlenmeyer flask. The Erlenmeyer flask was placed in a hood, followed by adding 100 ml of distilled water thereto, and left unattended in a 70° C. constant temperature water bath.

Next, the Erlenmeyer flask was cooled in a low-temperature water bath for 5 minutes. An Al dish was weighed and then placed on a hot plate.

The solution in the cooled Erlenmeyer flask was filtered into a prepared beaker using filter paper. Thereafter, 10 ml of the resulting filtrate was taken with a pipette, placed on the Al dish, and dried at a temperature of 165° C. for 30 minutes, followed by measuring the mass.

The crosslinking rate (gel content) was calculated according to Equation 1 below.

$$Crosslinking rate ( gel content ) ( \% ) = 100 - ( post - drying mass of filtrate / mass of film obtained by crosslinking copolymer composition ( 0.7 g ) ) * 500 \qquad [ Equation 1 ]$$

In Equation 1 above, the post-drying mass of the filtrate was calculated by subtracting the mass of the Al dish from the mass of the Al dish containing the filtrate dried at a temperature of 165° C. for 30 minutes.

### [Evaluation Example 2] Evaluation of Stability of Anode Slurry

The anode slurry, prepared according to Preparation Example 4, including each copolymer composition used in Examples 1 to 3 and Comparative Examples 1 to 4 was placed in a 30 ml vial and left unattended at room temperature for 7 days. Then, the occurrence of phase separation, unlike the initial state, was observed.

In the case where phase separation occurred, the stability was calculated according to Equation 2 below.

$$Anode slurry stability ( \% ) = ( phase - separated layer height / initial slurry height ) * 100 \qquad [ Equation 2 ]$$

### [Evaluation Example 3] Evaluation of Binding Strength of Binder

To measure the binding strength of the copolymer compositions (binders) used in Examples 1 to 3 and Comparative Examples 1 to 4, the copper current collector of the manufactured anode and the anode slurry layer formed on the copper current collector were attached to an acrylic plate and then peeled off at 180°, thereby measuring the binding strength using a universal testing machine (UTM).

### [Evaluation Example 4] Evaluation of Battery Performance

Three cycles of charge and discharge were performed on the lithium secondary batteries manufactured in Examples 1 to 3 and Comparative Examples 1 to 4 at a temperature of 25° C. under the following conditions: a charge and discharge current density of 0.1 C, a charge cut-off voltage of 4.8 V, and a discharge cut-off voltage of 2.7 V.

Then, the capacity retention rate was measured by performing 500 cycles of charge and discharge under the following conditions: a charge and discharge current density of 1 C, a charge cut-off voltage of 4.8 V, and a discharge cut-off voltage of 2.7 V.

The discharge was all performed under constant current/constant voltage conditions, and the discharge cut-off current of constant voltage was set to 0.005 C.

In this case, the capacity retention rate was calculated according to Equation 3 below.

$$Capacity retention rate ( \% ) = ( discharge capacity after 500 cycles / discharge capacity after 3 cycles ) * 100 \qquad [ Equation 3 ]$$

In addition, after the completion of the charge and discharge evaluation, each cell was disassembled to check thickness changes in the anodes, thereby comparing the effects of the copolymer composition binders used in Examples 1 to 3 and Comparative Examples 1 to 4 in suppressing silicon expansion.

In this case, the electrode expansion rate was calculated according to Equation 4 below.

$$Electrode expansion rate ( \% ) = ( thickness of anode after 200 cycles - thickness of vacuum - dried anode before assembly ) / thickness of vacuum - dried anode before assembly * 100 \qquad [ Equation 4 ]$$

### [Evaluation Example 5] Evaluation of LiF Content

Each cell was disassembled after the initial three discharge cycles of the lithium secondary batteries manufactured in Examples 1 to 3 and Comparative Examples 1 to 4, thereby measuring the LiF content on the surface of the anode by X-ray photoelectron spectroscopy (XPS).

Cell disassembly was performed in an Ar-filled glove box. The anode was rinsed with acetonitrile and transferred from a vacuum tube to the glove box connected to an XPS chamber, preventing the sample from being exposed to air.

XPS was performed on an area of 300 μm×700 μm using a Kratos Axis Supra XPS without a charge neutralizer, with a scan step size of 1.0 eV. High-resolution scans with a step size of 0.1 eV were measured for the C 1s, S 2p, and F 1s regions.

The crosslinking rate, the stability of the anode slurries, the binding strength of the binders, the capacity retention rate, the electrode expansion rate, and the LiF content, measured by Evaluation Examples 1 to 5, are shown in Table 1 below.

TABLE 1

| | Exam- | Exam- | Exam- | Comparative | Comparative | Comparative | Comparative |
|---|---|---|---|---|---|---|---|
| | ple 1 | ple 2 | ple 3 | Example 1 | Example 2 | Example 3 | Example 4 |
| pH of | 7 | 9 | 12 | 7 | 7 | 3 | 5 |
| copolymer | | | | | | | |
| composition | | | | | | | |
| Crosslinking | 80 | 60 | 50 | 87 | 55 | 90 | 85 |
| rate of | | | | | | | |
| copolymer | | | | | | | |
| composition | | | | | | | |
| (%) | | | | | | | |
| Stability of | 1 | 0.5 | 0 | 1 | 1 | 5 | 3 |
| slurry (%) | | | | | | | |
| Binding | 11.2 | 12 | 14 | 5.5 | 13 | 5.3 | 7.4 |
| strength | | | | | | | |
| (dyne/cm²) | | | | | | | |
| Capacity | 91 | 87 | 83 | 87 | 83 | 85 | 83 |
| retention | | | | | | | |
| rate at 500 | | | | | | | |
| cycles (%) | | | | | | | |
| Electrode | 38 | 52 | 55 | 31 | 57 | 30 | 34 |
| expansion | | | | | | | |
| rate at 500 | | | | | | | |
| cycles (%) | | | | | | | |
| LiF content | 78 | 78 | 80 | 79 | 77 | 76 | 79 |
| after | | | | | | | |
| formation | | | | | | | |
| (%) | | | | | | | |

As shown in Table 1 above, the crosslinking rates of the copolymer composition binders used in Examples 1 to 3 and Comparative Examples 1 to 4 were confirmed to decrease with the increasing pH (from acidic to basic).

In addition, at the same pH, the crosslinking rate was confirmed to increase with the increasing content of the crosslinking agent.

In the meantime, the height of the phase-separated layer decreased with the increasing pH, so the stability of the slurry was confirmed to increase.

When the measured stability value of the slurry is 3% or more (that is, the height of the phase-separated layer increases), as in the case of using the copolymer composition binder of Comparative Example 3 or 4, having a pH of lower than 6, the stability of the slurry is significantly reduced, and the processability of the anode manufacturing deteriorates, making the application thereof to an actual process challenging.

At the same pH, changes in the content of the crosslinking agent had no impact on the stability of the slurry.

With the increasing pH and the decreasing crosslinking rate, the binding strength of the copolymer composition binder was improved.

This is because, with the increasing crosslinking rate, the crosslinking rate of binding strength-improving functional groups also increases, so the effect of the binding strength-improving functional groups in improving binding strength is reduced.

In particular, in the case of using the copolymer composition binder of Comparative Example 3 or 4, having a pH of lower than 6, the binding strength of the copolymer composition binder was confirmed to be significantly reduced with the increasing degree of crosslinking.

In addition, at the same pH, the binding strength of the copolymer composition binder was reduced with the increasing content of the crosslinking agent.

In particular, in the case of using the copolymer composition binder of Comparative Example 1, using an excessive amount of the crosslinking agent, the binding strength was significantly reduced compared to the case of using the copolymer composition binder of Example 1 under the same pH condition.

The capacity retention rates of the batteries of Examples 1 to 3 and Comparative Examples 1 to 4 after 500 cycles of charge and discharge were improved with the increasing pH and the decreasing crosslinking rate. However, the capacity retention rates were measured to be reduced at a pH of 9 or higher.

In comparison, the electrode expansion rates of the batteries of Examples 1 to 3 and Comparative Examples 1 to 4 after 500 cycles of charge and discharge were measured to increase with the increasing pH and the decreasing crosslinking rate.

*In the case of using the copolymer composition binder of Comparative Example 3 or 4, having a pH of lower than 6, the electrode expansion rate was lower than that in the case of using the copolymer composition binder of Example 1 or 2, having a pH of 6 or higher, and thus the ability to suppress electrode expansion was better. However, the degree of crosslinking increases as described above, so most of the functional groups that help improve binding strength are crosslinked. As a result, the capacity retention rate of the battery is reduced.

In the meantime, in the case of using the copolymer composition binder of Comparative Example 1, using an excessive amount of the crosslinking agent, the electrode expansion rate was better than that in the case of using the copolymer composition binder of Example 1 under the same pH condition. However, the capacity retention rate was reduced.

In addition, in the case of using the copolymer composition binder of Comparative Example 2, using less than an appropriate amount of the crosslinking agent, the electrode expansion rate significantly increased compared to that in the case of using the copolymer composition binder of Example 1 under the same pH condition, and the capacity retention rate was reduced, confirming that the battery had reduced stability and degraded life characteristics.

After formation, the LiF content on the surface of the anodes of the batteries of Examples 1 to 3 and Comparative Examples 1 to 4 was all measured to be 80% or lower.

Even after crosslinking, carboxyl groups, which are not crosslinked, of the second copolymer remain, and such a carboxyl group can form a stronger hydrogen bond with fluorine than other functional groups. On this basis, the decomposition of the electrolyte salt, LiFSi, is facilitated, thereby forming an initial SEI layer, and then additional decomposition of SEI layers may be suppressed.

In other words, the copolymer composition of the present application can improve secondary battery performance by forming a stable SEI layer at an early stage.

Consequently, by appropriately adjusting the pH of the copolymer binder composition of the present application, in which the first copolymer, the second copolymer, and the crosslinking agent having a predetermined content are mixed, for crosslinking, the balanced dispersion stability of anode slurry compositions within an appropriate range, the binding strength of anodes, and the characteristics of secondary batteries (capacity retention rate and electrode expansion rate) were confirmed to be obtained.

In the meantime, in the case of using the copolymer binder composition in which the content of the crosslinking agent or the pH range did not fall within the scope of the present application, it was seen that one or more of the dispersion stability of anode slurry compositions, the binding strength of anodes, and the characteristics of secondary batteries were inappropriate for use in an actual secondary battery.

The scope of the present disclosure is defined by the appended claims rather than the detailed description presented above. All changes or modifications derived from the meaning and scope of the claims and the concept of equivalents should be construed to fall within the scope of the present disclosure.

### INDUSTRIAL APPLICABILITY

A copolymer composition of the present disclosure can be used in an anode slurry, thus increasing the binding strength to an anode current collector, and can suppress anode expansion, thus improving the capacity retention rate of a secondary battery per cycle.

1. A copolymer composition comprising:
a first copolymer comprising a vinyl alcohol monomer unit and a vinyl amine-based monomer unit;
a second copolymer comprising a vinyl alcohol monomer unit and an acrylic acid salt-based monomer unit; and
a crosslinking agent.

2. The copolymer composition of claim 1, wherein the first copolymer further comprises one or more selected from a vinyl acetate monomer unit and an N-vinylformamide-based monomer unit, and
the second copolymer further comprises one or more selected from an acrylate-based monomer unit and a vinyl acetate monomer unit.

3. The copolymer composition of claim 1, wherein the vinyl amine-based monomer unit is one or more selected from the group consisting of vinyl amine and 1-methyl vinyl amine, and
the acrylic acid salt-based monomer unit is one or more selected from the group consisting of acrylic acid and methacrylic acid.

4. The copolymer composition of claim 2, wherein the N-vinylformamide-based monomer unit is one or more selected from the group consisting of N-vinylformamide and N-isopropenylformamide, and
the acrylate-based monomer unit is one or more selected from the group consisting of methyl acrylate, methyl methacrylate, ethyl acrylate, ethyl methacrylate, propyl acrylate, propyl methacrylate, isopropyl acrylate, isopropyl methacrylate, butyl acrylate, butyl methacrylate, sec-butyl acrylate, sec-butyl methacrylate, tert-butyl acrylate, tert-butyl methacrylate, and ethyl hexyl methacrylate.

5. The copolymer composition of claim 1, wherein the first copolymer, based on 100 mol % of the total content thereof, comprises 50 mol % or more and 90 mol % or less of the vinyl alcohol monomer unit and 1 mol % or more and 50 mol % or less of the vinyl amine-based monomer unit, and
the second copolymer, based on 100 mol % of the total content thereof, comprises 1 mol % or more and 30 mol % or less of the vinyl alcohol monomer unit and 50 mol % or more and 90 mol % or less of the acrylic acid salt-based monomer unit.

6. The copolymer composition of claim 1, wherein the first copolymer comprises a monomer repeating unit represented by Formula 1 below, and
the second copolymer comprises a monomer repeating unit represented by Formula 2 below, 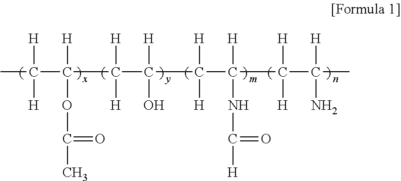
where in Formula 1, 0≤x≤15 mol %, 50≤y≤90 mol %, 0≤m≤30 mol %, and 1≤n≤50 mol %, and 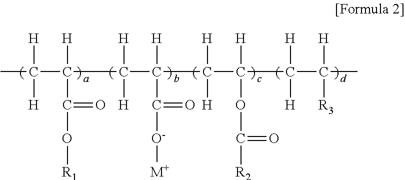
where in Formula 2, R₁ and R₂ are the same or different from each other and are each independently hydrogen or a straight-chain or branched-chain hydrocarbon having 1 to 5 carbon atoms,
R₃ is a hydroxyl (—OH) group,
M is an alkali metal,
0≤a≤5 mol %, 50≤b≤90 mol %, 0≤c≤5 mol %, and 1≤d≤30 mol %.

7. The copolymer composition of claim 1, wherein the copolymer composition, based on 100 wt % of the total weight of the first copolymer and the second copolymer, comprises 10 wt % or more and 90 wt % or less of the first copolymer and 10 wt % or more and 90 wt % or less of the second copolymer.

8. The copolymer composition of claim 1, wherein the crosslinking agent comprises 2 or more aldehyde groups.

9. The copolymer composition of claim 1, wherein the copolymer composition, based on 100 wt % of the total weight thereof, comprises 0.7 wt % or more and 2.8 wt % or less of the crosslinking agent.

10. The copolymer composition of claim 1, wherein the copolymer composition has a pH of 6 or higher and 12 or lower.

11. The copolymer composition of claim 1, wherein the first copolymer and the second copolymer of the copolymer composition have a crosslinking rate of 45% or higher and 80% or lower.

12. An anode slurry comprising:
the copolymer composition of claim 1; and
an anode active material.

13. An anode comprising:
a current collector; and
an anode active material layer comprising the copolymer composition of claim 1, the anode active material layer formed on the current collector.

14. (canceled)
